(19) United States
(12) Patent Application Publication
(10) Pub. No.: US 2012/0008982 A1
(43) Pub. Date: Jan. 12, 2012

(54) IMAGE FORMING APPARATUS TO CHARGE PHOTORECEPTOR IN NON-CONTACT MANNER AND CHARGING MEMBER

(75) Inventors: Daisuke Yamashita, Shizuoka-ken (JP); Takeshi Watanabe, Kanagawa-ken (JP); Shoko Shimmura, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/177,672

(22) Filed: Jul. 7, 2011

Related U.S. Application Data
(60) Provisional application No. 61/362,432, filed on Jul. 8, 2010.

(51) Int. Cl. G03G 15/00; G03G 15/02

(52) U.S. Cl. 399/159; 399/168

(57) ABSTRACT

An image forming apparatus includes a photoreceptor and a charging member. The photoreceptor includes a long-shaped raw pipe and a photoconductive layer that covers a center portion of the raw pipe in a longitudinal direction and forms exposed parts at ends of the raw pipe in the longitudinal direction. The charging member is arranged in parallel to the photoreceptor through a gap. The charging member includes a long-shaped conductive support body and a resistance adjustment layer that covers a center portion of the conductive support body in the longitudinal direction, and charges the photoconductive layer. Besides, the charging member includes a gap keeping member and a discharge preventing part. The gap keeping member is provided at a position outwardly spaced from a photoconductive layer opposite area by a specified distance in the longitudinal direction of the conductive support body, contacts the exposed part, and keeps a gap between the resistance adjustment layer and the photoconductive layer. The discharge preventing part covers a separation area between the resistance adjustment layer and the gap keeping member in the longitudinal direction of the conductive support body, and prevents discharge from the exposed part to the separation area.

### CROSS-REFERENCE TO RELATED APPLICATION

This application is based upon and claims the benefit of priority from U.S. provisional application 61/362,432, filed on Jul. 8, 2010; the entire contents of which are incorporated herein by reference.

### FIELD

Embodiments described herein relate generally to a charging technique to charge a photoreceptor in a non-contact manner.

### BACKGROUND

Hitherto, a non-contact type charging roller to charge a photoreceptor in a non-contact manner is used. A resistance adjustment layer to charge the photoreceptor is provided in a center portion of the charging roller in the longitudinal direction. Gap keeping members are provided at both sides of the resistance adjustment layer in the longitudinal direction of the charging roller. The gap keeping members contact the photoreceptor, and form a gap between the photoreceptor and the resistance adjustment layer. The resistance adjustment layer discharges in this gap and charges the photoreceptor in a non-contact manner.

However, when the non-contact type charging roller as stated above is used for a long period, a photoconductive layer is abraded by friction between the gap keeping member and the photoconductive layer on a surface of the photoreceptor, and to keep the gap between the photoreceptor and the resistance adjustment layer constant is difficult. As a result, the photoreceptor is not uniformly charged, and there is a fear that density unevenness appears in an image. When the abrasion further proceeds, a metal raw pipe as a substrate of the photoconductive layer is exposed, and leakage occurs between the exposed part and the resistance adjustment layer. That is, an excessive current flows through the exposed part, and there is a fear that image defects such as a color spot appears in an image.

### DESCRIPTION OF THE DRAWINGS

FIG. 1 is a perspective view of an image forming apparatus.

FIG. 2 is a schematic structural view showing an image forming part.

FIG. 3 is a schematic structural view for explaining a photoreceptor and a charging roller.

FIG. 4 is a view showing the whole structure of the photoreceptor and the charging roller.

FIG. 5 is a view for explaining a method of integrally forming a discharge preventing part and a gap keeping member.

FIG. 6 is a view showing an example of a discharge preventing part smaller than an outer diameter of a resistance adjustment layer.

FIG. 7 is an enlarged view showing a discharge preventing part including a cleaning part.

FIG. 8 is an enlarged view showing a discharge preventing part that functions as a cleaning part.

### DETAILED DESCRIPTION

In general, according to one embodiment, an image forming apparatus includes a photoreceptor and a charging member. The photoreceptor includes a long-shaped raw pipe and a photoconductive layer that covers a center portion of the raw pipe in a longitudinal direction and forms exposed parts at ends of the raw pipe in the longitudinal direction. The charging member is arranged in parallel to the photoreceptor through a gap. The charging member includes a long-shaped conductive support body, and a resistance adjustment layer that covers a center portion of the conductive support body in the longitudinal direction and charges the photoconductive layer. Besides, the charging member includes a gap keeping member and a discharge preventing part. The gap keeping member is provided at a position outwardly spaced from a photoconductive layer opposite area by a specified distance in the longitudinal direction of the conductive support body, contacts the exposed part, and keeps a gap between the resistance adjustment layer and the photoconductive layer. The discharge preventing part covers a separation area between the resistance adjustment layer and the gap keeping member in the longitudinal direction of the conductive support body, and prevents discharge from the exposed part to the separation area.

Hereinafter, embodiments will be descried with reference to the drawings.

### First Embodiment

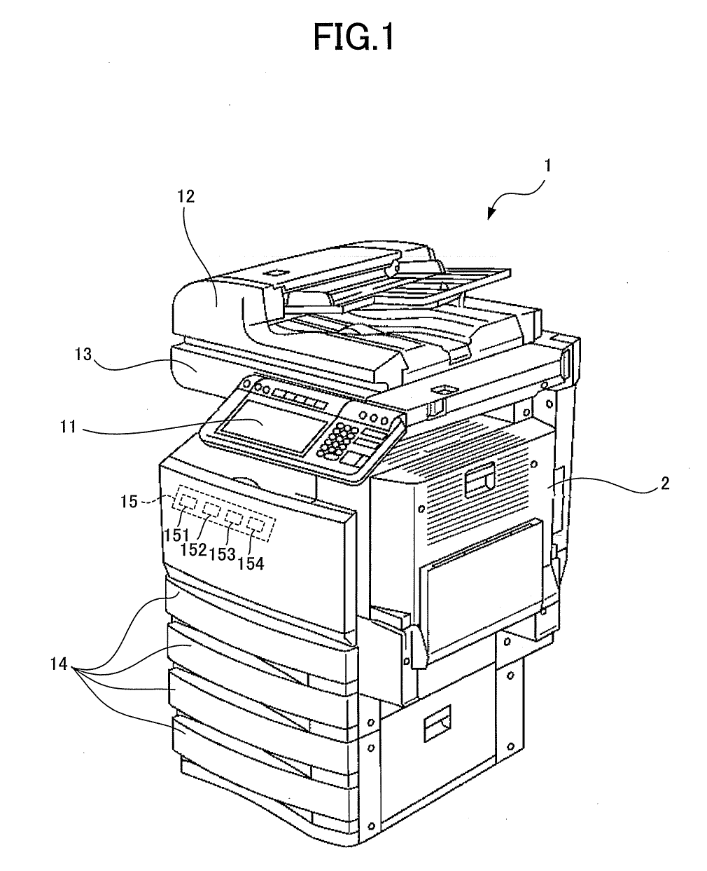

FIG. 1 is a perspective view of an image forming apparatus 1 which is an MFP (Multi Function Peripheral)

In the image forming apparatus 1, when a touch panel 11 receives an operation input of a user, an image reading part 13 reads a sheet set on an ADF 12, and a print job including image data and commands for the number of prints and the like is generated. The image forming apparatus 1 sends a sheet in any of paper feed cassettes 14 to an image forming part 2, and the image forming part 2 forms an image on the sheet based on the print job. The image forming apparatus 1 includes a control part 15. The control part 15 includes a processor 151, an ASIC 152 (Application Specific Integrated Circuit), a memory 153 and a HDD 154 (Hard Disk Drive), and controls the whole image forming apparatus 1.

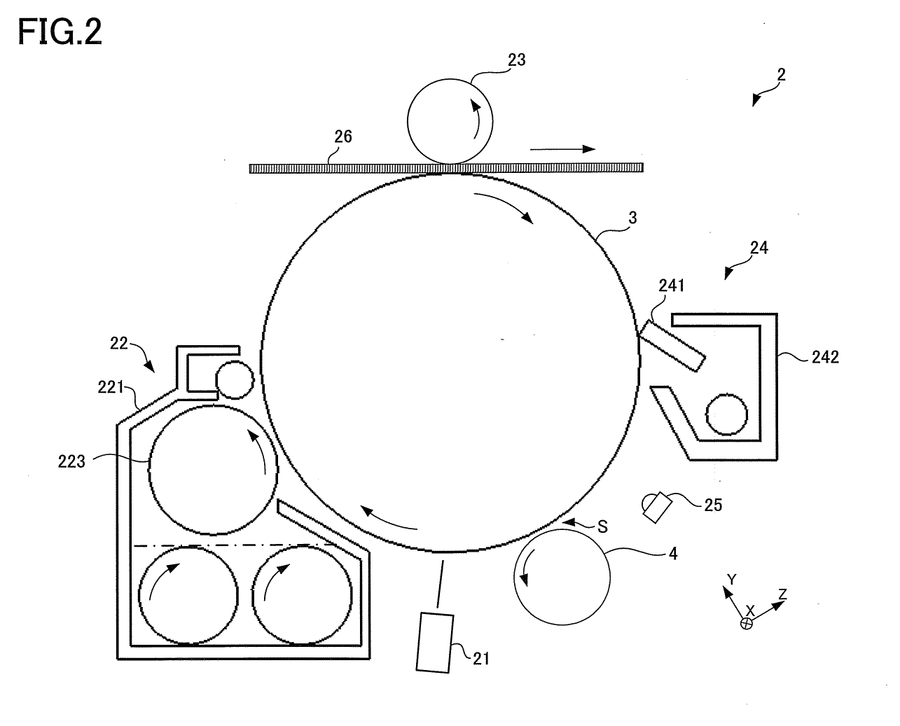

FIG. 2 is a schematic structural view showing the image forming part 2.

The image forming part 2 includes a photoreceptor 3, a charging roller 4 (charging member), an exposure device 21, a developing unit 22, a transfer member 23, a cleaning device 24 and a light charge removal device 25.

The charging roller 4 discharges in a gap S between itself and the photoreceptor 3, and uniformly negatively charges the photoreceptor 3. The exposure device 21 forms an electrostatic latent image on the photoreceptor 3 by laser light. The developing unit 22 supplies toner in a container 221 to the electrostatic latent image on the photoreceptor 3 by a developing roller 223, and forms a toner image on the photoreceptor 3. The transfer member 23 is applied with a positive bias voltage to form a transfer electric field between itself and the photoreceptor 3, and transfers the toner image on the photoreceptor 3 to a transfer target member 26 by this transfer electric field. The transfer target member 26 is a sheet, or a transfer roller or a transfer belt to transfer the toner image to a sheet. The cleaning device 24 scrapes a residual toner on the photoreceptor 3 by a blade 241 into a housing 242. The light charge removal device 25 irradiates light to the photoreceptor 3 and removes residual electric charge on the photoreceptor 3.

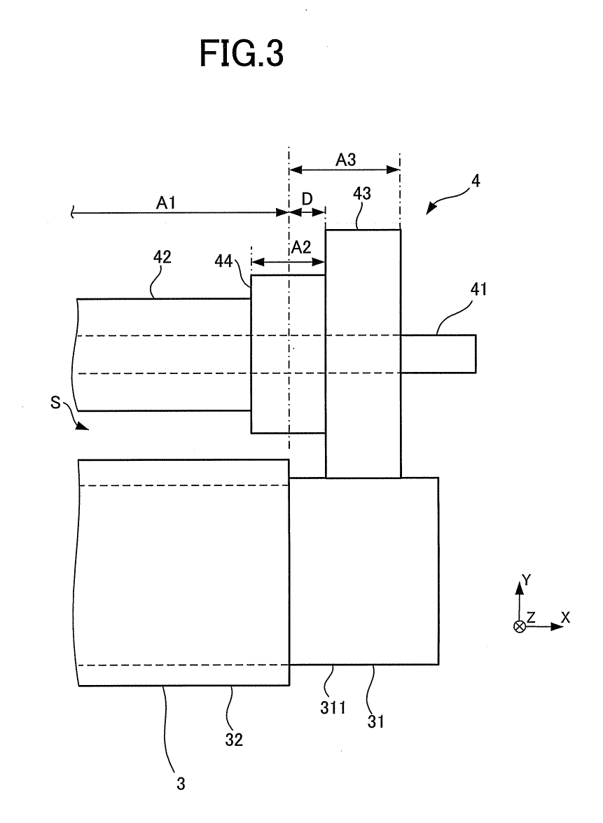

FIG. 3 is a schematic view for explaining a structure of the photoreceptor 3 and the charging roller 4.

The photoreceptor 3 includes a metal raw pipe 31 and a photoconductive layer 32.

The metal raw pipe 31 is a long-shaped metal pipe and includes an outer peripheral surface. The metal raw pipe 31 is made of metal such as aluminum.

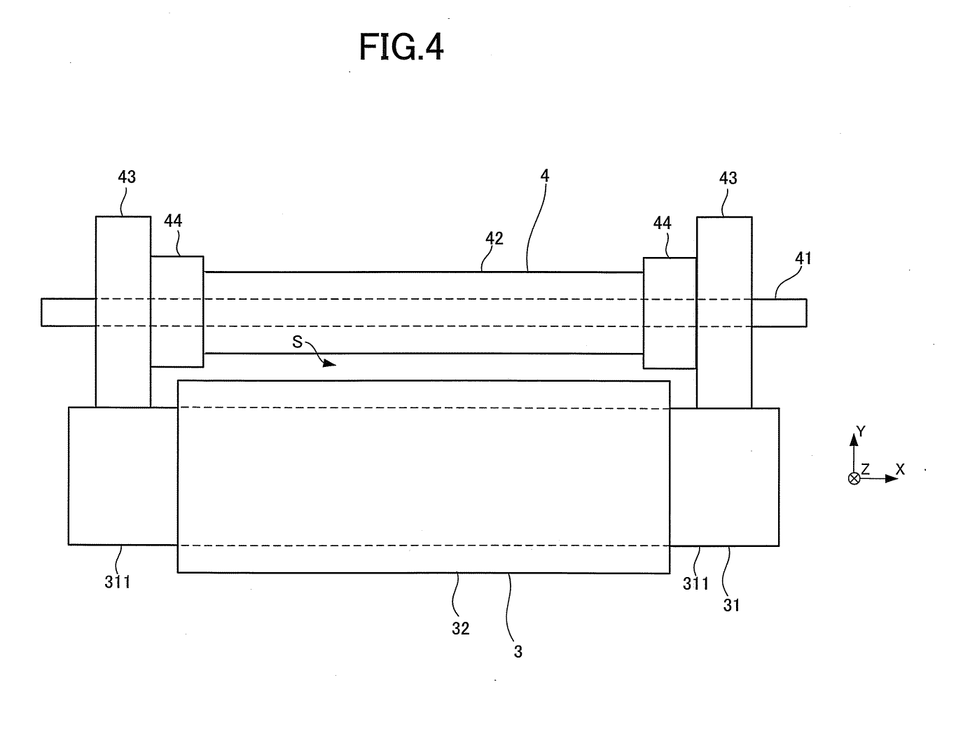

The photoconductive layer 32 covers the outer peripheral surface of a center portion of the metal raw pipe 31 in a longitudinal direction so that exposed parts 311 (see FIG. 4) exposed to the outside are formed at both ends of the metal raw pipe 31 in the longitudinal direction. The photoconductive layer 32 is formed on the metal raw pipe 31 by application. The exposed parts 311 as non-applied portions of the photoconductive layer 32 may be formed in such a manner that both the ends of the metal raw pipe 31 are masked when the photoconductive layer 32 is applied. The exposed parts 311 may be formed at both the ends of the metal raw pipe 31 in such a manner that after the photoconductive layer 32 is uniformly applied on the metal raw pipe 31 in the longitudinal direction, only the photoconductive layer located at both the ends of the metal raw pipe 31 is removed by a solvent or the like.

The charging roller 4 is arranged in parallel to the photoreceptor 3 through the gap S. The charging roller 4 includes a conductive support body 41, a resistance adjustment layer 42, a space keeping member 43 and a discharge preventing part 44.

The conductive support body 41 is long-shaped and includes an outer peripheral surface. The conductive support body 41 is a core metal formed of iron or stainless, and has conductivity.

The resistance adjustment layer 42 covers a center portion of the conductive support body 41 in the longitudinal direction, and charges the photoconductive layer 32. The resistance adjustment layer 42 is a conductive elastic body or resin composite. When a bias voltage is applied to the conductive support body 41, the resistance adjustment layer 42 discharges in the gap S and charges the photoconductive layer 32. The volume resistivity of a material used for the resistance adjustment layer 42 is preferably within a range of 10⁴ to 10¹⁰ (Ωcm). When the volume resistivity exceeds the range, a very high voltage is required to charge the resistance adjustment layer 42, and the cost increases and there is a fear that discharge does not occur. When the volume resistivity is less than the range, there is a fear that an electric leakage occurs in the photoreceptor 3 and the photoreceptor 3 can not be charged. The resistance adjustment layer 42 may be a resistance adjustment layer formed on the conductive support body 41 by application or the like, or may be a long-shaped and tubular member inserted onto the conductive support body 41. The thickness of the resistance adjustment layer 42 is set to, for example, 1 mm.

The gap keeping member 43 is provided in a flange shape at portions outwardly spaced from a photoconductive layer opposite area A1 by a specified distance D. The specified distance D is set to, for example, 1 to 5 mm. The outer diameter of the gap keeping member 43 is slightly larger than the outer diameter of the resistance adjustment layer 42. The gap keeping member 43 is, for example, a cylindrical member, and is press-inserted onto the conductive support body 41. The gap keeping member 43 is a resin composite that has a higher resistance than the resistance adjustment layer 42 or has an insulating property. The gap keeping member 43 contacts the exposed part 311 of the photoreceptor 3, and keeps the gap S between the resistance adjustment layer 42 and the photoconductive layer 32. The gap S is preferably set to 5 to 300 μm. When the gap S exceeds the range, the resistance adjustment layer 42 can not stably discharge, and it becomes difficult to uniformly charge the photoreceptor 3. When the gap S is less than the range, foreign matter such as toner or external additive becomes liable to move from the photoreceptor 3 to the charging roller 4, the photoreceptor 3 and the charging roller 4 become liable to partially contact each other, and the photoreceptor 3 becomes liable to receive mechanical damage. The length of the gap keeping member 43 in the axial direction is set to, for example, 5 to 10 mm.

The discharge preventing part 44 is an insulating or high-resistance member that covers a separation area A2 between the resistance adjustment layer 42 and the gap keeping member 43 in the longitudinal direction of the conductive support body 41, and prevents discharge from the exposed part 311 to the separation area A2. The length of the discharge preventing part 44 as the separation area A2 in the axial direction is set to, for example, 11 mm. The discharge preventing part 44 exists astride the photoconductive layer opposite area A1 and an exposed part opposite area A3 in the longitudinal direction of the conductive support body 41. The outer diameter of the discharge preventing part 44 is slightly larger than the outer diameter of the resistance adjustment layer 42 and is slightly smaller than the outer diameter of the gap keeping member 43. Since the discharge preventing part 44 has only to prevent electric leakage between the charging roller 4 and the exposed part 311 of the metal raw pipe 31, any material and any shape can be adopted as long as the discharge preventing part has a high resistance or an insulating property to such a degree that the leakage does not occur. When the resistance adjustment layer 42 or the gap keeping member 43 has a complicated three-dimensional shape, as long as the discharge preventing part 44 covers at least the separation area A2 between a cover portion of the resistance adjustment layer 42 with respect to the conductive support body 41 and a cover portion of the gap keeping member 43 with respect to the conductive support body 41, a part of the discharge preventing part 44 may enter between the resistance adjustment layer 42 and the conductive support body 41 or between the gap keeping member 43 and the conductive support body 41.

The discharge preventing part 44 may be a resin coating (discharge preventing layer) formed on the surface of the conductive support body 41. That is, the discharge preventing part 44 may be the resin coating applied on the conductive support body 41 and to the separation area A2 between the gap keeping member 43 and the resistance adjustment layer 42 after the gap keeping member 43 is press-inserted onto the conductive support body 41.

Besides, the discharge preventing part 44 may be a cylindrical member, for example, a resin tube or a foamed body. The charging roller 4 may be manufactured in such a manner that the respective members 43 and 44 are press-inserted in the order of the discharge preventing part 44 and the gap keeping member 43 onto each of both ends of the conductive support body 41 formed with the resistance adjustment layer 42.

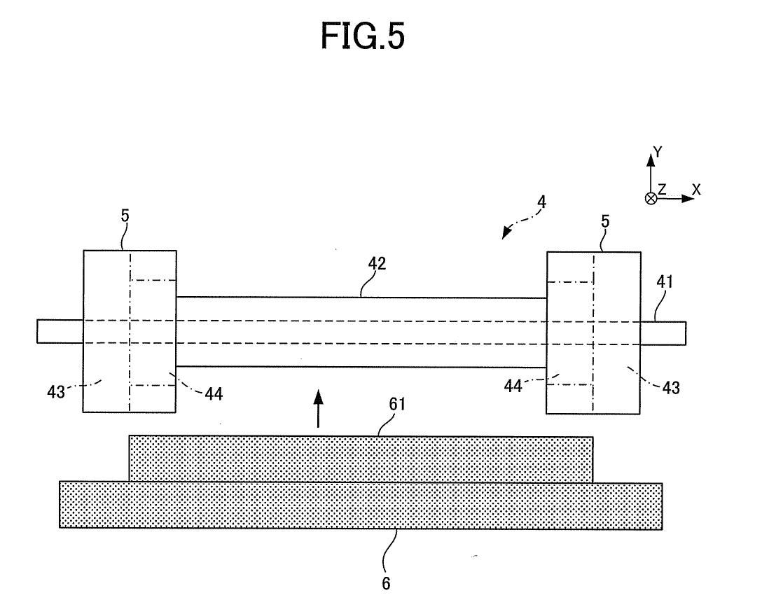

Besides, the discharge preventing part 44 may be a part of the gap keeping member 43. A manufacturing method of the charging roller 4 in this case will be described. First, as shown in FIG. 5, a cylindrical insulating or high-resistance resin composite 5 long in the axial direction is press-inserted onto each of both ends of the conductive support body 41 formed with the resistance adjustment layer 42. Next, a grindstone 6 provided with a wide protrusion 61 is prepared. While the conductive support body 41 and the resin composite 5 are rotated, the protrusion 61 of the grindstone 6 is pressed to the inside of the resin composite 5 in the axial direction, and scrapes away the inside, so that the discharge preventing part 44 is formed at the inside of the gap keeping member 43 in the axial direction, and the charging roller 4 is manufactured. As stated above, when the discharge preventing part 44 and the gap keeping member 43 are integrally formed, the charging roller 4 can be manufactured with high precision and low cost.

In this embodiment, the gap keeping member 43 does not contact the photoconductive layer 32, but contacts the exposed part 311 of the metal raw pipe 31. Thus, even if the image forming apparatus 1 is used for a long period, abrasion of the photoconductive layer 32 due to the contact with the gap keeping member 43 can be prevented. Thus, the gap S between the resistance adjustment layer 42 and the photoconductive layer 32 can be kept constant, and the photoreceptor 3 can be uniformly charged.

Besides, in this embodiment, in the longitudinal direction of the conductive support body 41, the discharge preventing part 44 covers the separation area A2 between the gap keeping member 43 and the resistance adjustment layer 42. Thus, the occurrence of the electric leakage between the exposed part 311 and the conductive support body 41 can be prevented. By these, in this embodiment, deterioration of image quality due to long use of the apparatus 1 can be prevented and the image quality can be kept excellent.

### Second Embodiment

Hereinafter, the same function part as that of the foregoing embodiment is denoted by the same reference numeral and a description thereof will be omitted.

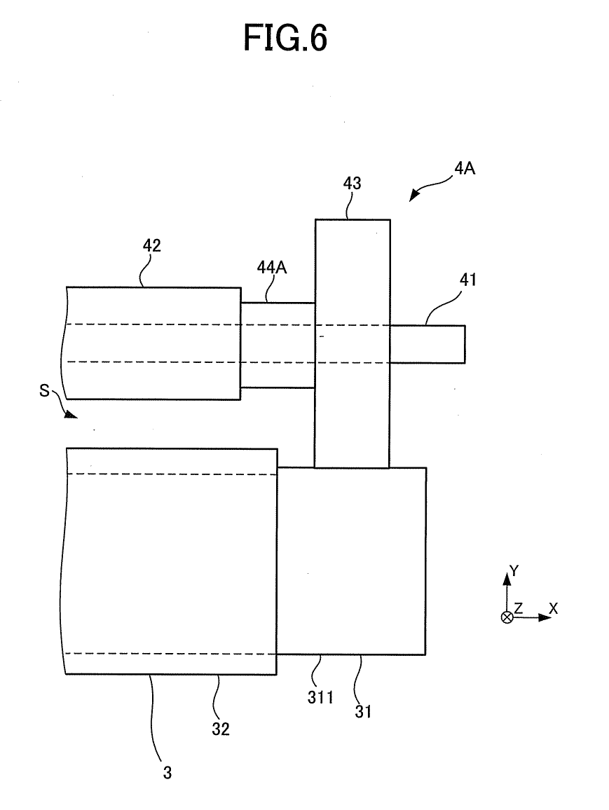

In this embodiment, as shown in FIG. 6, the outer diameter of a discharge preventing part 44A is smaller than the outer diameter of a resistance adjustment layer 42. Incidentally, the outer diameter of the discharge preventing part 44A may be equal to the outer diameter of the resistance adjustment layer 42.

### Third Embodiment

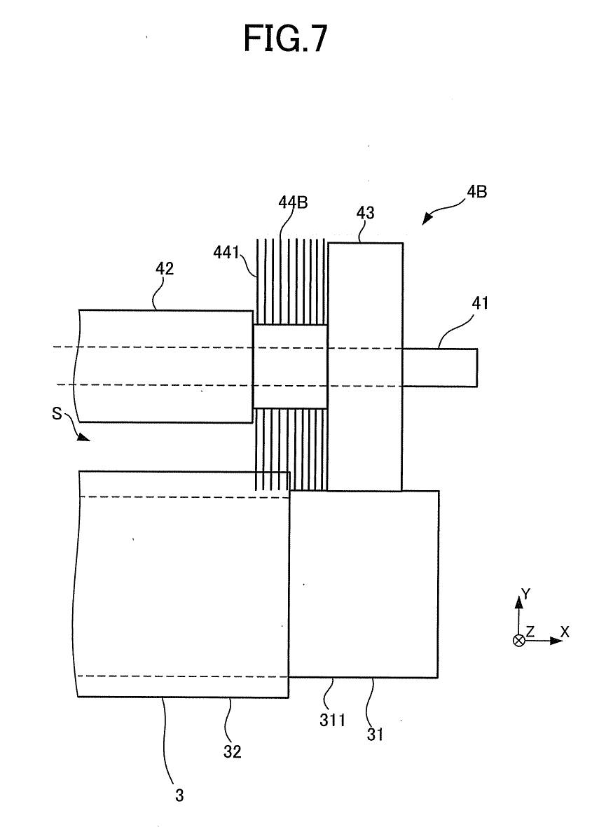

FIG. 7 is an enlarged view showing a discharge preventing part 44B located at one end of a charging roller 4B.

In this embodiment, the discharge preventing part 44B includes a cleaning part 441 to clean an end of a photoconductive layer 32. The cleaning part 441 is a brush fiber having a higher resistance than a resistance adjustment layer 42 or having an insulating property. The outer diameter of the cleaning part 441 is equal to the outer diameter of a gap keeping member 43 or is slightly larger than the outer diameter of the gap keeping member 43, and the cleaning part contacts the end of the photoconductive layer 32.

Also in this embodiment, the discharge preventing part 44B can prevent electric leakage from occurring between an exposed part 311 of a metal raw pipe 31 and a conductive support body 41.

Here, when foreign matter, such as toner or external additive, attached to the photoconductive layer 32 enters a contact surface between the exposed part 311 and the gap keeping member 43, a gap S between the resistance adjustment layer 42 and the photoconductive layer 32 varies, and uniform charging of a photoreceptor 3 is prevented. Against such a problem, in this embodiment, the cleaning part 441 scrapes the foreign matter attached to the end of the photoconductive layer 32, and prevents the foreign matter from entering the contact surface between the exposed part 311 and the gap keeping member 43. Thus, in this embodiment, the photoreceptor 3 can be sufficiently uniformly charged for a long period.

### Fourth Embodiment

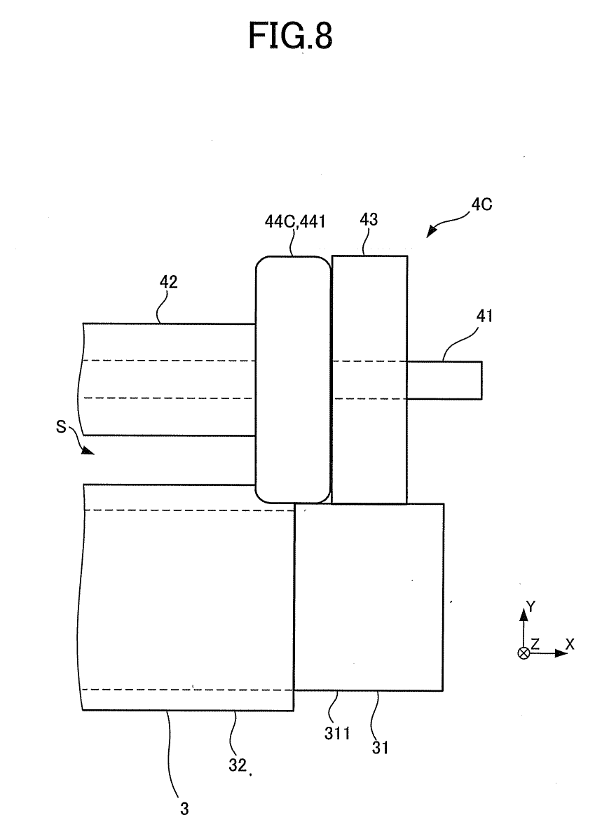

FIG. 8 is an enlarged view showing a discharge preventing part 44C located at one end of a charging roller 4C.

The discharge preventing part 44C (cleaning part 441) is an insulating sponge or rubber having a higher resistance than a resistance adjustment layer 42. The discharge preventing part 44C is cylindrical. The outer diameter of the discharge preventing part 44C is substantially equal to the outer diameter of a gap keeping member 43 and contacts a photoconductive layer 32.

Also in this embodiment, the discharge preventing part 44C can prevent electric leakage from occurring between an exposed part 311 and a conductive support body 41, and can prevent foreign matter from entering a contact surface between the exposed part 311 and the gap keeping member 43.

As described above in detail, according to the technique disclosed herein, the charging technique to charge the photoreceptor in a non-contact manner can be provided.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the sprit of the inventions. The accompanying claims and their equivalents are intended to cover such forms or modifications as would fall within the scope and spirit of the inventions.

What is claimed is:

1. An image forming apparatus comprising:
a photoreceptor including a long-shaped raw pipe, a photoconductive layer covering an outer peripheral surface of a center portion of the raw pipe in a longitudinal direction, and exposed parts at ends of the raw pipe in the longitudinal direction; and
a charging member arranged in parallel to the photoreceptor through a gap and including a long-shaped conductive support body, a resistance adjustment layer that covers a center portion of the conductive support body in the longitudinal direction and charges the photoconductive layer, a gap keeping member that is provided in a flange shape at a position outwardly spaced from a photoconductive layer opposite area by a specified distance in the longitudinal direction of the conductive support body, contacts the exposed part, and keeps a gap between the resistance adjustment layer and the photoconductive layer, and a discharge preventing part that covers a separation area between the resistance adjustment layer and the gap keeping member in the longitudinal direction of the conductive support body and prevents discharge from the exposed part to the separation area.

2. The apparatus of claim 1, wherein the resistance adjustment layer is arranged inside the photoconductive layer opposite area in the longitudinal direction of the conductive support body, and the discharge preventing part exists astride the photoconductive layer opposite area and an exposed part opposite area in the longitudinal direction of the conductive support body.

3. The apparatus of claim 2, wherein the discharge preventing part includes a cleaning part that contacts an end of the photoconductive layer and cleans the end.

4. The apparatus of claim 3, wherein the cleaning part is a foamed body.

5. The apparatus of claim 3, wherein the cleaning part is a brush fiber.

6. The apparatus of claim 1, wherein an outer diameter of the discharge preventing part is larger than an outer diameter of the resistance adjustment layer, and is smaller than an outer diameter of the gap keeping member.

7. The apparatus of claim 1, wherein an outer diameter of the discharge preventing part is smaller than an outer diameter of the resistance adjustment layer.

8. The apparatus of claim 7, wherein
the discharge preventing part is a part of the gap keeping member, and
a cylindrical resin composite is press-inserted onto an end of the conductive support body, an inside of the resin composite in an axial direction is scraped away while the conductive support body and the resin composite are rotated, and the discharge preventing part is formed inside the gap keeping member in the axial direction.

9. The apparatus of claim 1, wherein the discharge preventing part is a resin tube.

10. The apparatus of claim 1, wherein the discharge preventing part is a resin coating formed on a surface of the conductive support body.

11. The apparatus of claim 1, wherein the discharge preventing part is an elastic body.

12. A charging member arranged, through a gap, in parallel to a photoreceptor including a long-shaped raw pipe, a photoconductive layer covering an outer peripheral surface of a center portion of the raw pipe in a longitudinal direction, and exposed parts at ends of the raw pipe in the longitudinal direction, the charging member comprising:
a long-shaped conductive support body;
a resistance adjustment layer that covers a center portion of the conductive support body in the longitudinal direction and charges the photoconductive layer;
a gap keeping member that is provided in a flange shape at a position outwardly spaced from a photoconductive layer opposite area by a specified distance in the longitudinal direction of the conductive support body, contacts the exposed part, and keeps a gap between the resistance adjustment layer and the photoconductive layer; and
a discharge preventing part that covers a separation area between the resistance adjustment layer and the gap keeping member in the longitudinal direction of the conductive support body and prevents discharge from the exposed part to the separation area.

13. The member of claim 12, wherein the resistance adjustment layer is arranged inside the photoconductive layer opposite area in the longitudinal direction of the conductive support body, and the discharge preventing part exists astride the photoconductive layer opposite area and an exposed part opposite area in the longitudinal direction of the conductive support body.

14. The member of claim 13, wherein the discharge preventing part includes a cleaning part that contacts an end of the photoconductive layer and cleans the end.

15. The member of claim 14, wherein the cleaning part is a foamed body.

16. The member of claim 14, wherein the cleaning part is a brush fiber.

17. The member of claim 12, wherein an outer diameter of the discharge preventing part is larger than an outer diameter of the resistance adjustment layer and is smaller than an outer diameter of the gap keeping member.

18. The member of claim 12, wherein
the discharge preventing part is a part of the gap keeping member, and
a cylindrical resin composite is press-inserted onto an end of the conductive support body, an inside of the resin composite in an axial direction is scraped away while the conductive support body and the resin composite are rotated, and the discharge preventing part is formed inside the gap keeping member in the axial direction.

19. The member of claim 12, wherein the discharge preventing part is a resin tube.

20. The member of claim 12, wherein the discharge preventing part is a resin coating formed on a surface of the conductive support body.
